(19) United States
(12) Patent Application Publication
(10) Pub. No.: US 2006/0234896 A1
(43) Pub. Date: Oct. 19, 2006

(54) FLUSHING FOR REFRIGERATION SYSTEM COMPONENTS

(75) Inventors: Raymond H. Thomas, Pendleton, NY (US); Kane D. Cook, Eggertsville, NY (US); Anthony Manz, Paulding, OH (US)

Correspondence Address: HONEYWELL INTERNATIONAL INC., 101 COLUMBIA ROAD, P O BOX 2245, MORRISTOWN, NJ, 07962-2245, US

(73) Assignee: HONEYWELL INTERNATIONAL INC., Morristown, NJ (US)

(21) Appl. No.: 11/420,131

(22) Filed: May 24, 2006

Related U.S. Application Data
(62) Division of application No. 10/824,094, filed on Apr. 14, 2004.
(60) Provisional application No. 60/473,316, filed on May 22, 2003.

(51) Int. Cl. C11D 17/00

(52) U.S. Cl. 510/407

(57) ABSTRACT

A method and apparatus (10) for cleaning a component (14) of an air-conditioning or refrigeration system which provides for flushing liquid solvent through the component (14) to remove contamination from the component, vaporizing the solvent flushed through the component (14) followed by removing the contamination from the vaporized solvent so as to clean the solvent of the contamination, then liquefying the vaporized cleaned solvent and re-using the liquefied solvent to again flush the component (14).

### RELATED APPLICATIONS

This application is a divisional application of U.S. application Ser. No. 10/824,094 filed Apr. 14, 2004, which claims the benefit of U.S. Provisional Application No. 60/473,316, filed May 22, 2003, both of which are hereby incorporated herein by reference.

### FIELD OF THE INVENTION

The present application relates to systems for cleaning refrigeration systems such as air conditioning systems, and more particularly to a system for flushing contamination from such a system.

### BACKGROUND OF THE INVENTION

Air conditioning and refrigeration equipment can suffer from catastrophic failures such as compressor motor burnout. These failures may create contaminants within the sealed system which can include acids, sludges and particulates.

In order to protect the repaired system from a repeat failure, the heat exchangers or other components in such systems are usually flushed with a solvent to remove the contaminants. In the past, the solvent of choice was R11. As the CFCs and HCFCs have been shown to cause depletion of the ozone layer, however, R11 is no longer used for this purpose. R141b is still available for use in this manner, but manufacture of R141 is to cease in 2003. Thus another flushing solvent is needed.

The combination of new flushing solvents and equipment now available is inadequate. A typical problem with one type of equipment lies in the reuse of solvent which results in the transfer of contaminants from one air-conditioning system to another. Another method uses a simple flush which permits the solvent to be sprayed accidentally on to a worker using it. Purging of the solvent from the part to be cleaned also is time consuming.

There are many machines that are used for recovery, recycling or reclamation of refrigerants. These machines are not designed for use as flushing machines and do not provide adequate flushing service.

### SUMMARY OF THE INVENTION

Accordingly, the present invention provides a method for cleaning a component of an air-conditioning or refrigeration system that cleans and recycles the solvent as it is being used. Broadly, the invention provides for flushing liquid solvent through the air-conditioning component to remove contamination from the component. The solvent, having picked up the contamination, is then vaporized, followed by the removal of the contamination from the vaporized solvent so as to clean the solvent of the contamination. The cleaned solvent is then liquefied and recycled for use again in flushing the component. Thus the solvent is continuously cleaned and reused for flushing without the solvent becoming more and more contaminated with each use. After the cleaning of the component is completed, the solvent left over in the component can be recovered and the contamination which has been separated out of the solvent purged for disposal. An apparatus for carrying the above method is also provided.

### BRIEF DESCRIPTION OF THE DRAWING

The foregoing summary and the following detailed description may be better understood when read in conjunction with the accompanying drawings. For the purposes of illustrating the invention, a preferred embodiment is shown in the drawings. It is understood, however, that this invention is not limited to the precise arrangements shown.

FIG. 1 is a schematic diagram of a flushing machine for air conditioning and refrigeration devices.

### DETAILED DESCRIPTION

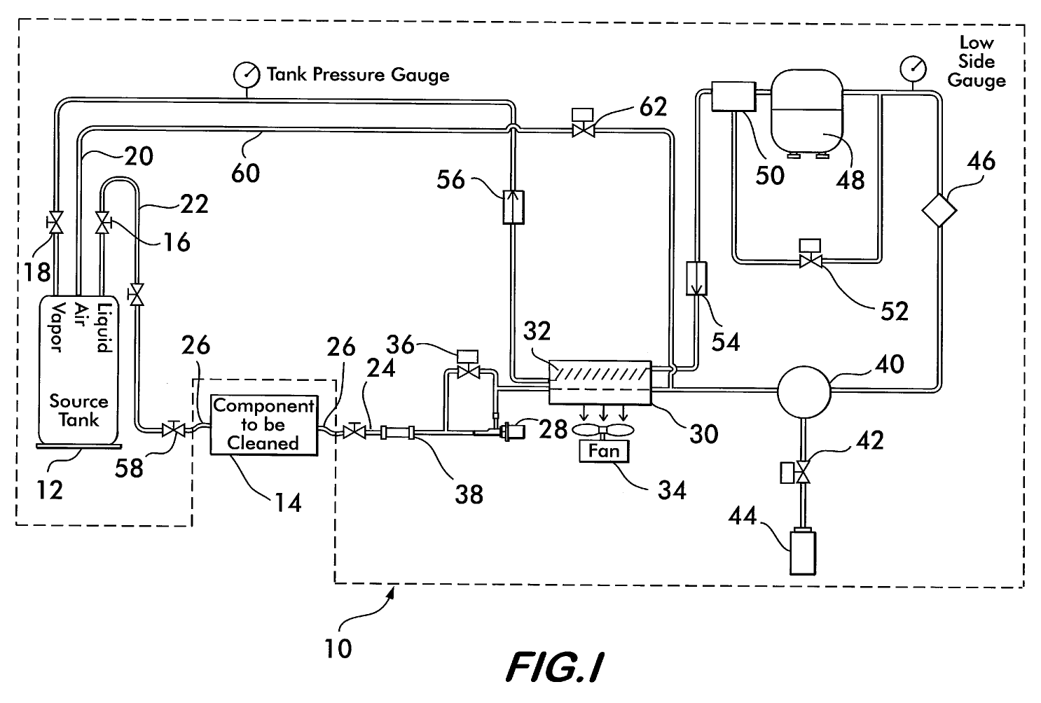

The present invention provides a method and apparatus for flushing air conditioning and refrigeration systems and components, and will be described with reference to FIG. 1. In general terms, the invention is carried out with an apparatus 10, as shown within the dotted lines, that delivers solvent from a closed supply tank 12 to an air conditioning component 14 to be cleaned. After passing through the component 14, the solvent picks up dissolved oil and other contaminants (referred to collectively as the “oil”) and then passes to other parts of the apparatus 10 where the solvent is cleaned of the contaminants and ultimately returned to the source tank 12 for further use. The method of the present invention is a multi-cycle system for carrying out at least the following: cleaning the component 14, purging the contamination collected by the solvent, and recovering the clean solvent for reuse. Thus it will be seen that the present invention provides a continuous source of clean solvent as described in further detail below.

In the cleaning cycle of the present invention, a component 14 of an air conditioning system (the other components of the air conditioning system not shown) is cleaned of contaminants. For example, the component 14 could be a condenser or heat exchanger from an air-conditioning or refrigeration unit in which the compressor motor burned out, overheating the oil in the compressor and creating contaminants. The component 14 is usually disconnected from the remainder of the air-conditioning system (fluidly disconnected, not necessarily removed from its mount in the engine compartment for example) so that it can be fluidly connected to the apparatus 10. Alternatively, various connected components of the air-conditioning system or the entire system can be connected to the apparatus 10.

The solvent to be used for cleaning the component is preferably a hydrofluorocarbon (HFC), such as HFC-245fa, which is stored in the source tank 12. A tank 12 holding between 1 and 100 lbs of solvent is preferable (portable tanks generally hold about 10 lbs). The source tank 12 also acts as a recovery tank for the recycled, but cleaned solvent. The tank 12 has several connections through which the vapor and liquid can move in and out of the tank. In the illustrated embodiment, a liquid take off valve 16 connects to a tube within the tank 12 for receiving liquid solvent from near the bottom of the tank; a valve 18 is connected for receiving recycled solvent; and another connection 20, which is preferably valved at the tank (not shown) can receive vapor from the upper portion of the tank 12. The number of valves can be minimized with use of known valves, such as a Y type valve which has both a liquid take off and a vapor take-off.

The component 14 is connected fluidly to the apparatus 10 so that the liquid solvent can be flushed through the component to remove any contamination. The solvent in the tank 12 is directed to the component 14 through a fluid conduit 22 which is connectable to the component 14, and the solvent exits the component 14 through another fluid conduit 24 connectable to the apparatus 10. The fluid conduits 22 and 24 may include valves as shown to open and close the flow of solvent, and preferably includes flexible hoses 26 or tubing sections for easy handling, and also a see through section, translucent section, or some type of view window so that the flow of solvent can be visually monitored. The component 14 is connected preferably to the apparatus 10 to be flushed with the solvent in a flow of solvent opposite the normal flow of refrigerant through the component 14 in normal use. Thus the solvent, in liquid form, passes from the tank 12 through the component 14 where it picks up the contamination, i.e., oil laden with waxes, dirt, fines and other debris caused by both normal wear and catastrophic failure.

The solvent exiting the component 14 is then evaporated into a gaseous form, leaving the oil in liquid form for removal from the gaseous solvent. This is accomplished by passing the solvent laden with contaminant (oil) from the component 14 through a restrictor valve 28, where the solvent begins to vaporize, and then an evaporator 30 to complete the vaporization process. A bypass valve 36, preferably solenoid operated, allows the expansion valve to be bypassed during the recovery cycle as further described below.

The evaporator 30 can be a combined three-coil unit where two coils are used as a condenser 32 as further described below, and one coil as the evaporator 30, allowing heat transfer between the evaporator 30 and condenser 32. A fan 34 blows air across the evaporator 30 and condenser 32 to enhance the heat exchange. Any suitable arrangement of heat exchangers can be used. A strainer 38 on the inlet side of the expansion valve is preferred to remove particulates.

The cold vapor solvent passes from the evaporator 32 to a helical oil separator 40, which separates any oil droplets and debris (the contamination) from the solvent vapor for collection as further described below. Any suitable type of separator may be used as is known in the art. The oil separator has an oil drain valve 42, preferably solenoid operated, for connection to an oil drain bottle 44, the operation of which is described below.

The vapor passes next through a filter/dryer 46 where any droplets of water remaining particulates are removed. Any suitable desiccant type dryer may be used. The filter/dryer may also have the capability of removing acid from the solvent.

Next the vapor passes to a compressor 48, which compresses the vapor to a hot vapor. As the hot vapor exits the compressor 48, it may take with it some of the compressor's oil used for lubricating the compressor 48. An oil separator 50, located downstream of the compressor, removes any such oil from the hot vapor and returns it to the compressor 34 through an oil return solenoid valve 52 which may be operated cyclically, intermittingly, or on a manner as known.

This hot vapor from the compressor 48 then passes through a check valve 54 to the fan cooled condenser 32 where it is condensed into hot liquid. The hot liquid is then returned to the source tank 12 through a check valve 56 and the tank valve 18 as clean solvent to be used again in the cleaning cycle. In this way the liquid solvent that is fed to component 14 is recycled and is always clean for reuse.

Once the component 14 has been sufficiently cleaned during the cleaning cycle, the solvent recovery cycle can be carried out. For this a valve on the outlet side of the tank 12, such as the valve 58 (or even tank valve 16) is closed to isolate the solvent source from the component 14, and the compressor 34 is turned on to remove all solvent from the component 14. Transparent sections of fluid conduits 22 and 26 allow an operator of the apparatus 10 to visually see when the solvent has stopped flowing, indicating that the solvent was completely removed from the component 14. Toward the end of the solvent recovery cycle, the recovery process can be sped up by bypassing the expansion valve 28 by opening the solenoid valve 36. This makes it easier to evaporate and remove any small amounts of remaining solvent in the component 14. Once all solvent has been recovered, the compressor can be shut off.

During the purge cycle, the oil is purged from the apparatus 10 and collected into the oil drain bottle 44. As shown, a fluid conduit 20 connected to the vapor in the tank 12 is connected through a fluid conduit 60 to the inlet side of the oil separator 40 (downstream of the evaporator 30). A solenoid controlled valve 62 controls the flow of vapor from the source tank 12 to the oil separator 40. For the purge cycle, with the valves to the component 14 closed, the compressor 48 is turned off and the solenoid controlled valve 62 opened to expose the helical oil separator 40 to the pressure of the source tank 12. With the opening of the oil drain solenoid valve 42, the pressure from the source tank 12 forces the oil and contaminates previously removed and held in the oil separator 40 into the oil drain bottle 44 for disposal. Draining the oil immediately after the clean cycle is believed to allow collection of a greater fraction of the oil from the component 14. The recovery cycle can then be done. Alternatively, however, the recovery cycle can be completed before the purge cycle if desired.

As discussed above, a preferred solvent for use with the present invention is HFC-245fa. Other suitable solvents may also be used, such as a combination of HFC-245fa and trans-1,2-dichloroethylene. For the mixture of HFC-245fa and trans-1,2-dichloroethylene, non flammable mixtures or mixtures with no flash point of the two should be used, such as a mixture of 65% HFC-245fa and 35% trans-1,2-dichloroethylene by weight, or 50% HFC-245fa and 50% trans-1,2-dichloroethylene by weight. Another possible solvent is HFC-365 mfc which when blended with HFC-245fa may provide a non-flammable mixture, e.g., a blend of 35% HFC-365 mfc and 65% HFC-245fa by weight. It is understood, however, that the present invention is not to be limited to the above mentioned solvents. Other solvents can be used, although such solvents should have certain preferable characteristics or properties.

First, solvents for the present application should preferably have no ozone depletion potential. A second criteria is that the solvent be non-flammable or have no flash point.

Finally, the solvent should not have too high of a boiling temperature. If the boiling temperature is too high, the solvent will not evaporate sufficiently across the restrictor valve 28 and in the evaporator. HFC-245fa is a low boiling solvent as compared to others, e.g., d-limonene, n-bromopropane, and HFE-7100, and is believed to be best suited for this application. Suitable solvents should fall within the boiling range of about 0° C. to about 61° C.; a more preferred range is about 5° C. to about 55° C.; and an even more preferred range is about 10° C. to about 45° C. As discussed above, the solvent should be classified as a non-flammable liquid according to DOT regulations. Most preferably the solvent has no flash point and no flammable range.

One use of the method of the present invention is to clean components of automobile air conditioning systems. It is believed that preferable flow rates of HFC-245fa as the solvent range between about 0.1 to about 10 pounds per minute, preferably 0.1 to 2 pounds per minute for automobile air-conditioning or smaller refrigeration systems cleaning. In one particular trial of the present method, the flow rate of the solvent in cleaning a condenser from an automobile was estimated as being 0.6 to 0.7 pounds of HFC-245fa per minute. For cleaning larger systems such as some rooftop air-conditioning systems, larger flows dependent on the total volume of the systems are required.

As discussed above, the restrictor valve 28 causes the evaporation of the solvent coming from the component. The extent to which this valve is opened is critical to the functioning of the device of the present invention. Under conditions of 25° C. and 1 bar, it has been found that if the valve is adjusted to 4 inches of mercury, the oil separation function works very well. However, it would be advantageous to have the valve operated automatically to provide a certain level of superheat, for instance 1 to 15° C. superheat at the compressor inlet. Various electronic means of achieving this are known in the industry which can be used for the present invention. The use of TXV valves designed for use with the solvents of this invention may also be possible. TXV valves designed for use with various refrigerants are available from Sporlan Valve Company, Parker-Hannifin Corp. and other suppliers. Using standard methods, such suppliers can provide TXV valves for use with the preferred solvents.

While it is understood that the solenoid valves shown in FIG. 1 are useful with an automated system, hand operated valves may also be used for a manual system. It is also understood that the various components of the apparatus are connected with fluid conduits, such as metal tubing and piping, with suitable valves and connectors as is known in the art.

In one trial of the method of the present invention, an automobile with an HFC-134a air conditioning system that had experienced compressor burnout was located. The refrigerant had leaked out. The failed compressor was removed. An apparatus similar to that described above was connected to the condenser of the air conditioning system. The condenser was then flushed for ten minutes with the solvent HFC-245fa. The apparatus was then run so as to remove all the HFC-245fa from the condenser. The lines to and from the car were transparent so that it was easy to see when the solvent stopped flowing indicating that the solvent was completely removed from the condenser. The oil that was drained from the oil collection tank was yellow-green with some dark particles in it.

In another trial, a condenser from an automobile was removed from the automobile and cleaned with a solvent. Eighty (80) grams of Mr. Goodwrench lubricant (a polyglycol) was poured into the condenser. Air was then blown into the condenser in such a manner that the oil was spread throughout the condenser. The oil-laden condenser was then attached to a flushing machine in accordance with the present invention. The apparatus was turned on. The solvent, HFC-245fa, flowed through the condenser. After 10 minutes, the flow of solvent was stopped and a recovery cycle initiated. During this cycle the compressor was run and the solvent remaining in the condenser was returned to the supply tank. The oil was then drained from the oil separator. Eighty (80) grams of oil were recovered. The condenser was weighed before and after and found to have the same weight indicating that all the oil and solvent were removed from it.

In yet another trial, 40 grams of mineral oil were added to a condenser from an automobile. Air was then blown into the condenser in such a manner that the oil was spread throughout the condenser. The oil laden condenser was then attached to a flushing machine in accordance with the present invention. The apparatus was then turned on. The solvent in this was a mixture of HFC-245fa (65 wt. %) and trans-1,2 dichloroethylene (35 wt. %), which is a non-flammable mixture. The solvent flowed through the condenser. After 10 minutes, the flow of the solvent was stopped and recovery cycle initiated. During this cycle the compressor was run and the solvent remaining in the condenser was returned to the supply tank. The oil was then drained from the oil separator. Forty grams of oil were recovered. The condenser was weighed before and after and found to have the same weight indicating that all the oil and solvent were removed from it. Here it is seen that the present invention can be used to flush the components of an older automobile air-conditioning system which may have used a hydrocarbon lubricant such as a mineral oil or alkyl benzene oils with a refrigerant such as R-12. A solvent such as HFC-245fa with a solubilizer such as trans-1,2 dichloroethylene is suitable for flushing such systems.

Thus it is seen that this invention allows for reuse of the solvent through constant redistillation and fast removal of the solvent from the component when the solvent boils close to room temperature. Such a machine can be automated and this operation can be made to operate with one push of a button when non-flammable HFC-245fa is used. The apparatus 10 can be a portable unit on wheels, with the solvent tank 12 easily connectable to the portable unit, or a stationary unit.

In contrast with methods and apparatuses of prior known devices, the method and apparatus of the present invention removes the contamination from the solvent before recycling the solvent back to the component. A further advantage of the present invention is that the time required for removal of the solvent from the component is reduced by about 30 to 50 percent in the case of the combination of a solvent suitable for the present invention, such as HFC-245fa, and the apparatus as compared to the use of higher boiling solvents such as an ester, heptane or limonene.

Changes and modifications in the specifically described embodiment can be carried out without departing from the scope of the invention which is intended to be limited only by the scope of the appended claims.

1-20. (canceled)

21. An apparatus using solvent to clean contamination from a component of an air-conditioning or refrigeration system and recovering and cleaning the solvent for reuse, said apparatus comprising the following:
a source of liquid solvent to be flushed through the component, said source being fluidly connectable to said component to deliver the solvent thereto;
an expansion valve for receiving the solvent after it is flushed through the component, said expansion valve being fluidly connectable to said component to receive the solvent there from;
an evaporator fluidly connected to said expansion valve for receiving the solvent that has exited the expansion valve and vaporizing the solvent;
a separator fluidly connected to said evaporator for removing said contamination from said vaporized solvent and thereby clean said solvent;
a compressor fluidly connected to said separator for compressing said vaporized solvent;
a condenser fluidly connected to said compressor for condensing said solvent back to a liquid, said condenser being fluidly connectable to said source of liquid solvent to return said solvent thereto.

22. The apparatus of claim 21 further comprising a fluid conduit connecting a vapor space in said source of liquid solvent to said separator so as to be capable of providing pressure from said source to said separator to purge contamination from said separator.

23. The apparatus of claim 21 wherein said apparatus is configured to operate with a solvent comprising a hydrofluorocarbon and having a boiling temperature in the range of about 0° C. to about 61° C.

24. The apparatus of claim 23 wherein said elements are configured to operate with solvent having a boiling temperature in the range of about 10° C. to about 45° C.

25. The apparatus of claim 21 further comprising a bypass fluid conduit and valve configured to allow bypass of the solvent around the expansion valve.

26-27. (canceled)
